(19) United States
(12) Patent Application Publication
(10) Pub. No.: US 2020/0260559 A1
(43) Pub. Date: Aug. 13, 2020

(54) SYSTEM CONFIGURATION USING A PORTABLE MEDIA DEVICE

(71) Applicant: SIGNIFY HOLDING B.V., EINDHOVEN (NL)

(72) Inventors: JONATHAN DAVID MASON, WAALRE (NL); DZMITRY VIKTOROVICH ALIAKSEYEU, EINDHOVEN (NL)

(21) Appl. No.: 16/639,291

(22) PCT Filed: Aug. 9, 2018
(86) PCT No.: PCT/EP2018/071646

§ 371 Date: Feb. 14, 2020

(30) Foreign Application Priority Data
Aug. 14, 2017 (EP) 17186111.5

(51) Int. Cl. H05B 47/125; H05B 47/19; G06F 3/01; G06F 3/16

(52) U.S. Cl. CPC H05B 47/125; H05B 47/19; G06F 3/167; G06F 3/016; G06F 3/012

(57) ABSTRACT

A system and associated method for configuring the system are provided, the system having one or more components for providing a sensory effect to a user, the user having a portable media device configured to interoperate with the system, the method comprising: (i) displaying to or receiving from a user (26) of the media device (20) an instruction relating to configuration of the one or more components of the system, the instruction having an expected physical response by the user (26); (ii) receiving data from a sensor incorporated within the media device (20), arranged to detect a physical response of the user (26); and (iii) determining whether a detected physical response of the user (26) is associated with the displayed or received instruction. The system may be an illumination, audio, display, heating, cooling or other environmental control system and the method enables the system to be configured more accurately and completely.

### TECHNICAL FIELD

The present disclosure relates to configuration of systems using portable or hand-held media devices, in particular to configuration of systems providing a sensory effect. The present disclosure relates in particular to configuration of illumination systems using a portable or hand-held media device.

### BACKGROUND

Illumination systems are known, for example the Hue™ personal lighting kit supplied by the present Applicant. The Hue™ personal lighting kit provides one or more controllable light sources and a bridge device. The bridge device may be linked to the Internet so that the light sources may be configured and controlled from anywhere to provide a variety of different user-definable illumination effects. It is also known to configure such systems using a portable or hand-held media device such as a ‘smart’ mobile phone with access to the Internet. Downloadable software modules, or ‘apps’, are available to execute on a mobile phone to enable a user of the device to interact with the illumination system components via the bridge device and to configure the system.

Other types of system are known to provide an interface to enable their configuration or operation using mobile phones executing ‘apps’ or other portable computing devices executing installed configuration software. Such systems may include domestic and commercial environmental control systems, entertainment systems, sound systems, lighting systems etc. Such systems may have in common a need for a user to be physically present when configuring certain features. It may for example be necessary for the user to confirm that a particular component of the system is producing an intended sensory effect, from an intended position.

In the particular example of an illumination system, one element of a typical configuration procedure involves defining a position of one or more lights of the illumination system relative to a user. This may require the user to input details of a physical arrangement of light sources to a user interface provided by an app executing on a mobile phone. The mobile phone stores or shares with the illumination system bridge a virtual representation of the arrangement of light sources. The user may be required, via the user interface, to verify that the virtual arrangement matches the physical arrangement. If the physical arrangement of light sources is different to that defined in the mobile phone app or the bridge, different lights may be activated to those the user intended.

### SUMMARY

According to a first aspect disclosed herein, there is provided a method for configuring a system having one or more components for providing a sensory effect to a user, the user having a portable media device configured to interoperate with the system, the method comprising:

(i) displaying to or receiving from a user of the media device an instruction relating to configuration of the one or more components of the system, the instruction having an expected physical response by the user;
(ii) receiving data from a sensor incorporated within the media device, arranged to detect a physical response of the user; and
(iii) determining whether a detected physical response of the user is associated with the displayed or received instruction.

By this method, a configuration process that is intended to be interactive is more likely to be completed accurately and as intended. The use of a portable or hand-held media device having one or more built-in sensors enables a number of ways to detect a physical response by the user.

In an example embodiment, the sensor is a camera incorporated into the media device and the media device is configured to detect, at step (ii), a physical response of the user by analysis of image data received from the camera. There are a number of known image data analysis techniques that may be used to detect a physical response.

In an example embodiment, the media device is configured to detect, at step (ii), a change in orientation of the head of the user relative to the media device when the head of the user is within the field of view of the camera.

In an example embodiment, the media device incorporates a movement sensor arranged to output data relating to movement of the media device and wherein the media device is configured to detect, at step (ii), a physical response of the user by analysis of movement data received from the movement sensor. It has been found, for example, that a slight downward tilt of the media device may be indicative of an intended head movement.

In an example embodiment, the method comprises:

(iv) in the event, at step (iii), that a physical response of the user is not detected or is not associated with the displayed or received instruction, generating a prompt condition to trigger a physical response by the user. The prompt condition may for example comprise at least one of: displaying a message to the user; suspending updates to a display of the media device; generating an audible signal; and causing the media device to vibrate. It has been found that prompts of these types may be generated to distract the user or otherwise break the user's attention to what is being displayed by the media device. By these means, the user may be more likely to respond as intended.

In an example embodiment, the one or more components of the system comprise: an acoustic source; a display; a source of ventilation; a source of heat; a cooling device; a light source; and an obscuring device. Configuration of a system involving any such components may benefit from the present invention to verify an expected interaction by a user.

In an example embodiment, the system is an illumination system and the one or more components comprise one or more light sources located in a vicinity of the user, the portable media device being configured to interoperate with the illumination system.

In such an application, in an example embodiment, the media device is configured to determine or to receive data defining a location of the one or more light sources relative to the media device and to detect, at step (ii), a change in orientation of the head of the user relative to the known location of the one or more light sources. In this way, the direction in which the user looks may be determined and compared with the known location of the one or more light sources. In this way, the media device and the illumination system may be able to detect which of the light sources the user is looking at.

In an example embodiment applied to an illumination system, step (i) comprises triggering a visible indication by one of the one or more light sources and the expected physical response comprises the user orienting his or her head in approximately the direction of the light source.

According to a second aspect disclosed herein, there is provided a media device configured to control a system having one or more components for providing a sensory effect to a user, the media device being configured to interact with the system and with a user to configure the system, including: displaying to or receiving from the user an instruction regarding configuration of the one or more components of the system, the instruction having an expected physical user response; receiving data from a sensor incorporated within the media device to detect a physical response of the user; and determining whether a detected physical response of the user is associated with the displayed or received instruction.

In an example embodiment, the media device incorporates at least one of a camera and a movement sensor and the media device is configured to detect a physical response of the user by analysis of image data received from the camera or by analysis of movement data received from the movement sensor.

In an example embodiment, the media device is configured to generate a prompt condition to trigger a physical response by the user in the event that a physical response of the user is not detected or is not associated with the displayed or received instruction.

According to a third aspect disclosed herein, there is provided an illumination system comprising:

one or more light sources; and

an interface to a media device to enable configuration of the illumination system by the media device, the interface and the media device being arranged to implement the method as described above according to the first aspect disclosed herein, in particular when applied to configuration of an illumination system.

According to a fourth aspect disclosed herein, there is provided a computer program comprising computer program code which when installed in and executed by a computer processor causes the computer processor to implement the method as described above according to the first aspect disclosed herein.

### BRIEF DESCRIPTION OF THE DRAWINGS

To assist understanding of the present disclosure and to show how embodiments may be put into effect, reference is made by way of example to the accompanying drawings in which:

FIG. 1 shows schematically components of an illumination system to which example embodiments in the present disclosure may be applied; and

FIG. 2 is a flow chart showing a configuration procedure according to example embodiments in the present disclosure.

### DETAILED DESCRIPTION

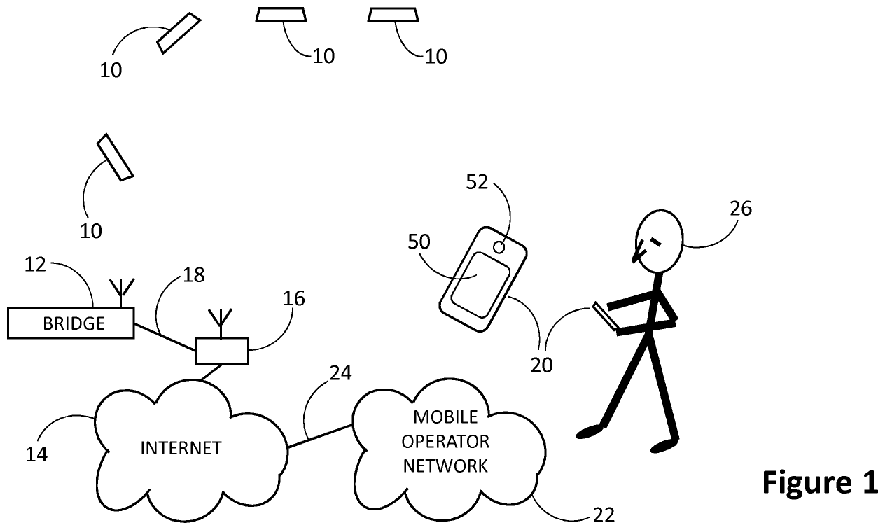

An example embodiment of an invention to be described below will be presented in the context of a configurable illumination system. An illumination system is one example of a system that may provide a sensory experience to a user. Such systems often require, for configuration of components of the system, some level of interaction with the user. A simple example of a known illumination system to which the invention may be applied will firstly be described in outline with reference to FIG. 1.

Referring to FIG. 1, an arrangement of controllable lights 10 is shown, each linked wirelessly to a bridge device 12 for controlling the lights 10 to provide a predetermined or user-defined illumination effect. The bridge device 12 may be linked to the Internet 14 via a network service provider's router 16. The bridge device 12 may communicate with the router 16 by means of an Ethernet or equivalent linking cable 18 or wirelessly.

A mobile phone 20 or other portable or hand-held media device 20 may execute software to enable the media device 20 to communicate with the bridge 12 of the illumination system. The media device 20 may communicate with the bridge 12 over the Internet via an associated mobile service provider's network 22 and Internet gateway 24. Alternatively, if within range, the media device 20 may establish a local wireless link, for example by means of a local wi-fi network controlled by the router 16, for example. In this way, a media device 20 enables a user 26 to interact with the bridge 12 to configure the lights 10 and to design or select an illumination effect to be provided.

In other examples of illumination systems, a controller may be provided to implement a combination of the functionality of the bridge 12, a selection of the functionality that may otherwise be implemented by software executing on a portable or hand-held media device 20, and functionality otherwise implemented within the lights 10 of the system. A person of ordinary skill in the relevant art would be aware of the range of possible ways to distribute functionality across such a system to implement embodiments of the present invention. In a simplification, the light sources 10 in an illumination system may optionally implement little or no functionality and be controllable by a separate controller supplying power to the lights 10 over hard-wired links to generate a required illumination effect.

In one example of a configuration procedure that may be implemented by means of software executing on the media device 20, a graphical user interface is provided to enable the user 26 to input details via the media device 20, of the physical arrangement of lights 10 relative to one another, relative to the media device 20 or relative to the user 26. At one stage of such a configuration procedure, the media device 20, via the bridge 12, may cause a light 10 to flash and instruct the user, via the graphical user interface, to verify which of the lights 10 has flashed. The user 26 may provide the verification by reference to an image displayed on the media device 20 showing a virtual representation of lights. However, users have been found occasionally to indicate an incorrect light 10 on the display when instructed, one reason being that the user 26 did not look at the lights 10 when instructed and so did not see which of the lights 10 was flashing.

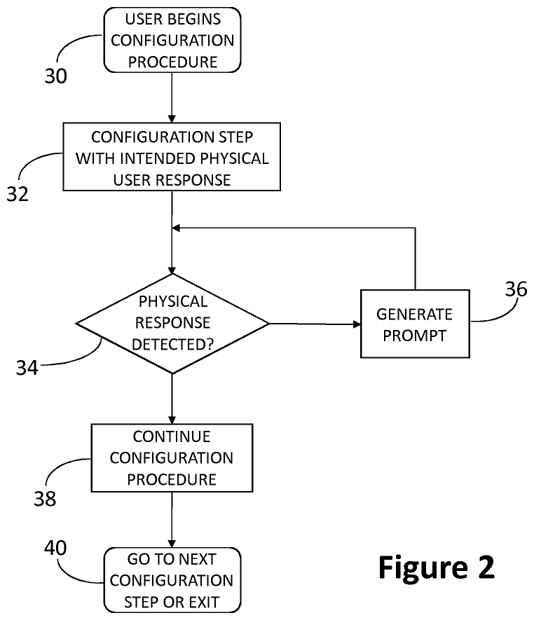

One example embodiment of the invention provides a modified configuration procedure for an illumination system such as that shown in FIG. 1 which will now be described with reference to FIG. 1 and additionally with reference to FIG. 2.

Referring additionally to FIG. 2, a flow chart is provided showing steps in a configuration procedure for an illumination system with the aim to increase the probability that a user will interact with the illumination system as intended.

Beginning at STEP 30, the user 26 initiates a configuration procedure and at STEP 32 reaches a step in the configuration procedure where the user 26 is expected to respond physically. For example, in response to an instruction displayed on a display 50 of the media device 20, the user 26 may be expected to turn his or her head to look at something, for example a flashing light 10, to confirm which of the lights 10 is flashing. Alternatively, the user 26 may be instructed to orient the media device 20 so that it is oriented towards a particular light 10 of the illumination system.

If, at STEP 34, no response is detected that corresponds to the physical response expected then, at STEP 36, a prompt is generated in an attempt to prompt the user 26 to respond physically as expected. The prompt may for example comprise ‘freezing’ the display 50 of the media device 20 being used to perform the configuration procedure, or generating a visible or audible message at the media device 20 or at a component of the illumination system requiring some attention by the user. If, following generation of the prompt, a corresponding physical response is detected at STEP 34, then the procedure continues at STEP 38 and, at STEP 40, either the user 26 moves on to the next step in the procedure or exits the procedure.

A configuration procedure as described with reference to FIG. 2 may be implemented using a fixed, portable or hand-held media device. However, this procedure is particularly suited to use with portable, and in particular hand-held media devices 20 such as ‘smart phones’. Such devices have built-in sensors, such as accelerometers and one or more cameras 52 that may be used according to the invention to implement STEP 34 in the procedure of FIG. 2. Some example implementations of STEP 34 and some of the physical responses of a user that might be detected and exploited in the present invention will now be described in more detail. Such functionality may be applied to a media device 20 being used in the configuration or operation of any system requiring an interaction involving components providing a sensory effect to which the user 26 may be expected to respond.

In one example embodiment of the invention, a configuration step is implemented by the media device 20 to instruct the user 26 to enter details using the media device 20 of a physical arrangement of lights 10 or other components of the illumination system. In particular, the user 26 may be required to enter or to confirm the physical location or direction of lights 10 relative to the user 26, to the display device 20 or relative to each other. A virtual representation of the physical arrangement of lights 10 may be displayed on the display 50 of the media device 20.

A configuration step may ask the user 26 to confirm which of the lights 10 in the physical arrangement correspond to lights shown in the displayed virtual representation. To help the user 26 to achieve this, the media device 20 may communicate with the bridge 12 and trigger one of the lights 10 to flash, or to generate another optical effect to indicate which of the lights 10 is to be associated with a light shown in the displayed virtual representation. For example, the media device 20 may display an instruction to the user 26 to look up at the lights 10 and to confirm whether the physical light 10 that is flashing corresponds to a highlighted light in the displayed virtual representation.

In a simple embodiment of the invention, the media device 20 may be arranged to determine, at STEP 34 of the procedure of FIG. 2, whether the user 26 has turned his or her head to look away from the media device 20. The media device 20 may capture image data from its user-facing camera 52 of at least the head of the user 26 and process the image data on the media device 20. In this way, the configuration software may detect a head turning movement of the user 26. There are numerous known techniques by which such image data analysis may be performed to detect head movement, for example by reference to external databases of head images in various orientations or by capturing and referring to images of the user 26 captured during an earlier configuration of the media device 20 by the user 26.

Other detectable evidence of a simple physical response of the user 26 includes a movement of the media device 20 itself. It has been found that when a user 26 looks up, the user 26 tends to tilt the media device 20 slightly downwards. Such a change in orientation of the media device 20 at the time expected may be detected by the executing configuration software using data from accelerometers incorporated within the media device 20.

In a more complex embodiment of the invention, by analysis of image data from the camera 52 and movement data from the accelerometers of the media device 20, a direction of head movement may be determined relative to a determined orientation of the media device 20. The configuration software executing on the media device 20 may then determine whether the user 26 was looking towards a particular light 10 or at least in the general direction of a particular light 10. The media device may also compare the determined direction with the assumed relative position of a light 10 highlighted in the displayed virtual representation and thereby obtain further evidence that the user 26 has responded as expected if the two directions approximately correspond.

In particular, the expected user response may be defined as the user 26 looking in the direction of a particular light 10. The test of whether a user has responded as expected would in that case be a comparison of a detected direction of looking by the user 26 with a known direction of the physical light 10 relative to the user 26. If the user 26 is found to be looking in a different direction, a conditional prompt may be generated, for example to indicate a suggested change in the detected direction of looking.

If a direction of head movement can be determined with some confidence, the determined direction of head movement may itself be used as an input to a configuration step of the procedure in which confirmation is required from the user 26 that a particular physical light 10 was flashing. This may be achieved if the relative position of the lights 10 and the user 26 has already been established and is provided to or stored by the configuration software and/or by the bridge 12.

In a further embodiment of the invention, the media device 20 may be used to detect an event such as a flashing light 10 by analysis of image data from the in-built camera 52 and, by analysis of accelerometer data, the orientation of the media device 20 at the time of detecting the event. The physical response expected of the user 26 in such an embodiment may involve orienting the camera 52 of the media device 20 towards the light 10 when instructed. In this way, the physical response of the user 26 is confirmed, at STEP 34 of the procedure, by the detection of a flashing light by the camera 52 and by an expected change in orientation of the media device 20. Furthermore, the orientation of the media device 20 relative to a start position enables the configuration software or the bridge 12 to determine the relative direction of the light 10, for example to the position of the user 26 and, by similar steps, the relative directions of all the lights 10 in the illumination system.

In another example embodiment of the invention implementing STEP 34 of the procedure, evidence of a physical response by the user 26 may include a pause of a predetermined duration by the user in his or her use of a graphical user interface being displayed (50) by media device 20. For example, the media device 20 may detect a delay between successive touches of a touch-screen display 50 of the media device 20 that corresponds with the timing of the expected physical response of the user 26.

If no evidence is detected of an expected physical response, such as by the methods outlined above, then one or more different types of prompt may be generated under the control of the configuration procedure software executing on the media device 20 or via the illumination system bridge 12 when triggered by the configuration procedure software. Such prompts are intended to break the user's attention to what is being displayed on the media device 20 for long enough to prompt an expected physical response by the user 26. Examples of different types of prompt may include one or more of the following:
display a message on the display 50 of the media device 20;
change the appearance of what is being displayed on the display 50 of the media device 20;
suspend update of the display 50 of the media device 20 for a predetermined time period;
suspend acceptance of user input to the media device 20 for a predetermined time period;
generate an audible sound at the media device 20;
trigger an event via the bridge 12 of the illumination system, for example a predetermined flashing sequence of a respective light 10, or generate an audible sound at the light 10 if it is provided with such a facility; and
cause the media device 20 to vibrate.

Other types of prompt may be generated as would occur to a person of ordinary skill in the relevant art. Options for generating prompts may depend upon the facilities provided by the media device 20, by the illumination system or by any related devices controllable by the configuration software executing on the media device 20 or by the bridge 12 of the illumination system. In particular, conditional prompts may be generated to take account of any difference between an actual detected response of the user 26 and an intended response of the user 26. For example, if the user 26 is found to be looking in an incorrect direction, a prompt may be generated to indicate how the user 26 is to change their direction relative to the detected direction, for example by displaying a direction arrow. In another example, if an audible prompt does not result in a required physical response, a louder audible prompt may be generated after a predetermined time period, or a different type of prompt may be generated to that generated previously.

As mentioned above, the procedure described with reference to FIG. 2 may be implemented entirely by software executing on a portable or hand-held media device such as a mobile phone. Where required, data may be received wirelessly via a bridge or from a controller of the illumination system to be configured, but the steps in the procedure according to the present invention do not necessarily require additional functionality to be provided in components of the illumination system.

In an alternative implementation of embodiments of the present invention, some of the functionality described above may be implemented by additional software installed and executing on a bridge or controller of the system. Numerous examples of a distribution of the functionality described above between a portable or hand-held media device 20, a bridge 12, components of the system or a controller of the system would be apparent to a person of ordinary skill in the relevant art, without departing from the principles of configuration functionality according to the present invention.

A bridge 12 or controller of a system may be implemented using a conventional digital data processor having associated memory. A computer program may be stored in the memory and executed by the digital processor to implement selected functionality described above. Alternatively, a combination of configured hardware logic devices and conventional digital data processing hardware may be used to implement the selected functionality.

The media device 20 may be a conventional mobile phone, tablet or laptop computer with a network interface by means of which computer program code may be downloaded and installed on the device and executed to implement relevant functions described above. Such mobile phone devices may use the Android® operating system or any of the proprietary operating systems used by known mobile phone manufacturers. Portable devices such as tablets and laptop computers may use respective proprietary or open standard operating systems. Respective mobile phone service or Internet service provider interfaces may be installed to enable wireless connection to the Internet or to a local wireless network as required to communicate with the system to be configured.

If a portable device such as a tablet or laptop computer is to be used as the media device 20 to operate the configuration procedure described above, then it may be that the only sensor in the device 20 for detecting a physical response by a user 26 will be a built-in camera 52. A movement sensor may not be available to implement embodiments intended to take account of movement of the media device 20. If the device 20 is provided with movement sensors, the device 20 may nevertheless be operated in a fixed position. It is not therefore essential in the present invention for the media device 20 to have other than a camera 52 for detecting a physical response of the user 26.

Where wireless communications are required between components of a system, communications according to one of the known wireless communications standards may be implemented, for example according to IEEE 802.11 or Bluetooth®. In embodiments of the invention described above, wireless communications according to such standards may be implemented: between the illumination system bridge device 12 and the Internet router 16; between the illumination system bridge device 12 and the lights 10; between the media device 20 and the Internet router 16; or between the media device 20 and the illumination system bridge device 12.

Other variations to the disclosed embodiments may be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for configuring a system having one or more components for providing a sensory effect to a user, the user having a media device configured to interoperate with the system, the method comprising:
(i) displaying to a user of the media device an instruction relating to configuration of the one or more components of the system, the instruction having an expected physical response by the user caused by the user performing said configuration of the one or more components;
(ii) receiving data from a sensor incorporated within the media device, wherein the sensor is a camera arranged to detect, as a physical response of the user by analysis of image data received from the camera, a change in orientation of the head of the user relative to the media device when the head of the user is within the field of view of the camera; and
(iii) determining whether the detected physical response of the user is associated with the displayed instruction.

2. (canceled)

3. (canceled)

4. The method according to claim 1, wherein the media device incorporates a movement sensor arranged to output data relating to movement of the media device and wherein the media device is further configured to detect, at step (ii), the physical response of the user by analysis of movement data received from the movement sensor.

5. The method according to claim 1, further comprising:
(iv) in the event, at step (iii), that a physical response of the user is not detected or is not associated with the displayed or received instruction, generating a prompt condition to trigger a physical response by the user.

6. The method according to claim 5, wherein the prompt condition comprises at least one of: displaying a message to the user; suspending updates to a display of the media device; generating an audible signal; and causing the media device to vibrate.

7. The method according to claim 1, wherein the one or more components of the system comprise: an acoustic source; a display; a source of ventilation; a source of heat; a cooling device; a light source; and an obscuring device.

8. The method according to claim 1, wherein the system is an illumination system and the one or more components comprise one or more light sources located in a vicinity of the user, the media device being configured to interoperate with the illumination system.

9. The method according to claim 8, wherein the media device is configured to determine or to receive data defining a location of the one or more light sources relative to the media device and to detect, at step (ii), a change in orientation of the head of the user relative to the known location of the one or more light sources.

10. The method according to claim 8, wherein step (i) comprises triggering a visible indication by one of the one or more light sources and the expected physical response comprises the user orienting his or her head in approximately the direction of the light source.

11. A media device configured to control a system having one or more components for providing a sensory effect to a user, the media device being configured to interact with the system and with a user to configure the system, including: displaying to the user an instruction regarding configuration of the one or more components of the system, the instruction having an expected physical response by the user caused by the user performing said configuration of the one or more components; receiving data from a sensor incorporated within the media device, wherein the sensor is a camera arranged to detect, as a physical response of the user by analysis of image data received from the camera, a change in orientation of the head of the user relative to the media device when the head of the user is within the field of view of the camera; and determining whether the detected physical response of the user is associated with the displayed instruction.

12. (canceled)

13. The media device according to claim 11, configured to generate a prompt condition to trigger a physical response by the user in the event that a physical response of the user is not detected or is not associated with the displayed or received instruction.

14. An illumination system comprising:
one or more light sources; and
an interface to a media device to enable configuration of the illumination system by the media device, the interface and the media device being arranged to implement the method according to claim 8.

15. A computer program comprising computer program code which when installed in and executed by a computer processor causes the computer processor to implement the method according to claim 1.
